(19) United States
(12) Patent Application Publication
(10) Pub. No.: US 2018/0120672 A1
(43) Pub. Date: May 3, 2018

(54) IMAGE SURVEILLANCE DEVICE AND LIGHT EMITTING MODULE THEREOF

(71) Applicant: VIVOTEK INC., New Taipei City (TW)

(72) Inventors: Chung-Yon Huang, New Taipei City (TW); Shih-Hsuan Hung, New Taipei City (TW)

(21) Appl. No.: 15/730,708

(22) Filed: Oct. 11, 2017

(30) Foreign Application Priority Data
Oct. 27, 2016 (TW) 105134651

(51) Int. Cl. G03B 15/03; G03B 17/56; F21K 9/68; F21K 9/66; H04N 5/235; H04N 7/18; H04N 5/225

(52) U.S. Cl. CPC G03B 15/03; G03B 17/561; F21K 9/68; F21Y 2115/10; H04N 5/2354; H04N 7/183; H04N 5/2252; F21K 9/66

(57) ABSTRACT

An image surveillance device is mounted on a corner wall structure having a first side surface, a second side surface, and a ceiling surface and includes a casing and an image capturing module. The casing includes a containing plate, a cover, and a mounting plate detachably fixed to the first side surface, the second side surface, and the ceiling surface. The containing plate is detachably contained in the mounting plate and has an opening and a containing groove recessed inwardly from the opening. The cover detachably covers the opening and has a first transparent mask. The image capturing module is disposed in the containing groove. An oblique angle is included between an optical axis of the image capturing module and the ceiling surface, so as to make the image capturing module obliquely monitor a surveillance region corresponding to the corner wall structure through the first transparent mask.

### BACKGROUND OF THE INVENTION

### 1. Field of the Invention

The present invention relates to an image surveillance device and a light emitting module thereof, and more specifically, to an image surveillance device having a cover detachably disposed on a containing plate and a cup structure having an inverted-trapezoid cup rim and a light emitting module thereof.

### 2. Description of the Prior Art

In general, an image surveillance device for indoor surveillance is mounted on a corner wall structure to obliquely monitor a surveillance region corresponding to the corner wall structure. For preventing the image blur problem caused by insufficient indoor illumination, the image surveillance device usually has a light emitting module (e.g. an infrared LED module) disposed thereon for providing auxiliary light. Accordingly, the image surveillance device can still capture clear images even when the image surveillance device is operated in a dark environment.

However, in the aforesaid design, there are usually the image underexposure problem occurred at an area of interest in the surveillance region and the wall image overexposure problem occurred at a corner area in the surveillance region. Furthermore, since the image surveillance device adopts the design that a cover is integrally formed with a front casing or is disposed on a lens module in a screw locking manner, it causes a time-consuming and strenuous cover replacement process.

### SUMMARY OF THE INVENTION

The present invention provides an image surveillance device mounted on a corner wall structure. The corner wall structure has a first side surface, a second side surface, and a ceiling surface. The image surveillance device includes a casing and an image capturing module. The casing includes a mounting plate, a containing plate, and a cover. The mounting plate is detachably connected to the first side surface, the second side surface, and the ceiling surface to be fixed to the corner wall structure. The containing plate is detachably contained in the mounting plate. The containing plate has an opening and a containing groove recessed inwardly from the opening. The cover detachably covers the opening and has a first transparent mask. The image capturing module is disposed in the containing groove corresponding to the first transparent mask. An oblique angle is included between an optical axis of the image capturing module and the ceiling surface to make the image capturing module obliquely monitor a surveillance region corresponding to the corner wall structure through the first transparent mask.

The present invention further provides an image surveillance device mounted on a corner wall structure. The corner wall structure has a first side surface, a second side surface, and a ceiling surface. The image surveillance device includes a casing, an image capturing module, and at least one light emitting module. The casing is detachably connected to the first side surface, the second side surface, and the ceiling surface to be fixed to the corner wall structure. The image capturing module is disposed in the casing. An oblique angle is included between an optical axis of the image capturing module and the ceiling surface to make the image capturing module obliquely monitor a surveillance region corresponding to the corner wall structure. The light emitting module is disposed in the casing and adjacent to the image capturing module for providing the image capturing module with light when the image capturing module monitors the surveillance region. The light emitting module includes a cup structure and a light emitting unit. The cup structure has an inverted-trapezoid bottom surface, a first reflection surface, a second reflection surface, a third reflection surface, a fourth reflection surface, and an inverted-trapezoid cup rim. An area of the inverted-trapezoid bottom surface is less than an area of the inverted-trapezoid cup rim. The first reflection surface extends from a topline of the inverted-trapezoid bottom surface to a topline of the inverted-trapezoid cup rim. The second reflection surface extends from a baseline of the inverted-trapezoid bottom surface to a baseline of the inverted-trapezoid cup rim. The third reflection surface and the fourth reflection surface extend from two lateral sides of the inverted-trapezoid bottom surface to two lateral sides of the inverted-trapezoid cup rim respectively. The light emitting unit is disposed on the inverted-trapezoid bottom surface. Light emitting by the light emitting unit is incident to the surveillance region via reflection of the first reflection surface, the second reflection surface, the third reflection surface, and the fourth reflection surface.

The present invention further provides a light emitting module. The light emitting module provides light to an image capturing module mounted on a corner wall structure when the image capturing module obliquely monitors a surveillance region. The light emitting module includes a cup structure and a light emitting unit. The cup structure has an inverted-trapezoid bottom surface, a first reflection surface, a second reflection surface, a third reflection surface, a fourth reflection surface, and an inverted-trapezoid cup rim. An area of the inverted-trapezoid bottom surface is less than an area of the inverted-trapezoid cup rim. The first reflection surface extends from a topline of the inverted-trapezoid bottom surface to a topline of the inverted-trapezoid cup rim. The second reflection surface extends from a baseline of the inverted-trapezoid bottom surface to a baseline of the inverted-trapezoid cup rim. The third reflection surface and the fourth reflection surface extend from two lateral sides of the inverted-trapezoid bottom surface to two lateral sides of the inverted-trapezoid cup rim respectively. The light emitting unit is disposed on the inverted-trapezoid bottom surface. Light emitting by the light emitting unit is incident to the surveillance region via reflection of the first reflection surface, the second reflection surface, the third reflection surface, and the fourth reflection surface.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an image surveillance device being mounted on a corner wall structure according to an embodiment of the present invention.

FIG. 2 is an exploded diagram of the image surveillance device in FIG. 1.

FIG. 3 is a top view of a light emitting module in FIG. 2.

FIG. 4 is a cross-sectional diagram of the light emitting module in FIG. 3 along a cross-sectional line A-A.

FIG. 5 is a cross-sectional diagram of the light emitting module in FIG. 3 along a cross-sectional line B-B.

FIG. 6 is a lighting pattern diagram of the light emitting module in FIG. 3.

FIG. 7 is a side view of an image capturing module in FIG. 2 being disposed in a containing groove.

FIG. 8 is a diagram of a second transparent mask in FIG. 2 being flat on an inverted-trapezoid cup rim of a cup structure.

### DETAILED DESCRIPTION

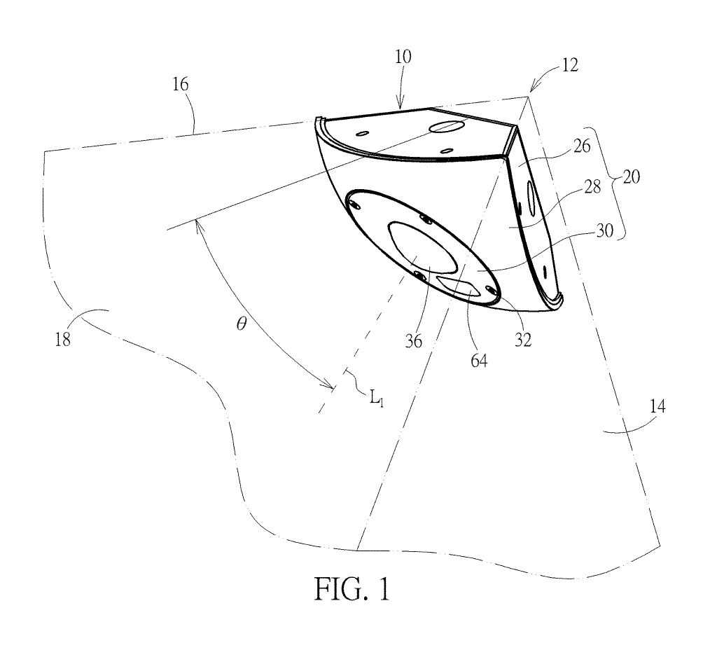

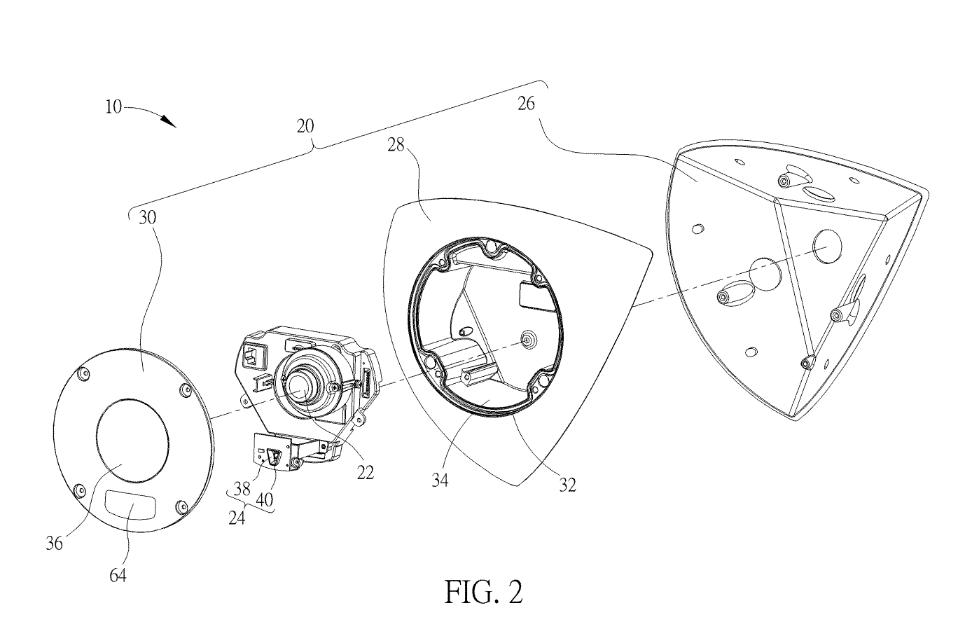

Please refer to FIG. 1 and FIG. 2. FIG. 1 is a diagram of an image surveillance device 10 being mounted on a corner wall structure 12 according to an embodiment of the present invention. FIG. 2 is an exploded diagram of the image surveillance device 10 in FIG. 1. For clearly showing the design of the image surveillance device 10, the corner wall structure 12 is briefly depicted by dotted lines in FIG. 1. As shown in FIG. 1 and FIG. 2, the corner wall structure 12 could have a first side surface 14, a second side surface 16, and a ceiling surface 18. The first side surface 14, the second side surface 16 and the ceiling surface 18 could preferably be perpendicular to each other, but not limited thereto. The image surveillance device 10 is detachably mounted on the corner wall structure 12 to be a corner camera for performing indoor surveillance on a surveillance region of interest corresponding to the corner wall structure 12.

To be more specific, the image surveillance device 10 includes a casing 20, an image capturing module 22, and at least one light emitting module 24 (one shown in FIG. 2, but not limited thereto). The casing 20 includes a mounting plate 26, a containing plate 28, and a cover 30. The mounting plate 26 could be detachably connected to the first side surface 14, a second side surface 16, and a ceiling surface 18 to be fixed on the corner wall structure 12 for subsequent installation of the containing plate 28. The containing plate 28 is detachably contained in the mounting plate 26 and has an opening 32. A containing groove 34 is recessed inwardly from the opening 32. The cover 30 detachably covers the opening 32 and has a first transparent mask 36, and the image capturing module 22 is disposed in the containing groove 34 corresponding to the first transparent mask 36. An oblique angle θ (preferably 45°, but not limited thereto) is included between an optical axis L₁ of the image capturing module 22 and the ceiling surface 18. Accordingly, the image capturing module 22 can obliquely monitor a surveillance region corresponding to the corner wall structure 12 through the first transparent mask 36. To be noted, the present invention could adopt a conventional detachable design, such as a screw locking design or a structural engagement design, for connecting the mounting plate 26 to the first side surface 14, the second side surface 16, and the ceiling surface 18 respectively, for connecting the containing plate 28 to the mounting plate 26, and for connecting the cover 30 to the containing plate 28, and the related description is well known to a person skilled in the art and omitted herein for simplicity.

Via the aforesaid designs, when a user wants to mount the image surveillance device 10 on the corner wall structure 12, the user just needs to fix the mounting plate 26 to the corner wall structure 12 and dispose the image capturing module 22 in the containing groove 34 of the containing plate 28 in advance, and then disposes the containing plate 28 in the mounting plate 26. After an image capturing angle of the image capturing module 22 is set (i.e. adjustment for the oblique angle θ), the user fixes the cover 30 to the containing plate 28 for covering the opening 32, so as to complete the mounting process of the image surveillance device 10. In such a manner, via the aforesaid three-piece casing design for connecting the containing plate 28 having the image capturing module 22 disposed therein to the mounting plate 26 and cover 30, the user can mount the image surveillance device 10 on the corer wall structure 12 quickly, so as to greatly improve installation convenience of the image surveillance device 10.

On the other hand, if the user wants to replace the cover 30 (e.g. when the first transparent mask 32 on the cover 30 is damaged artificially), the user can directly detach the cover 30 from the containing plate 28 for the subsequent cover replacement process since the cover 30 is detachably disposed on the containing plate 28 to cover the opening 32. Accordingly, since there is no need to detach the other components (e.g. the image capturing module 22) from the image surveillance device 10, the present invention can efficiently solve the prior art problem that a conventional image surveillance device adopts the design that a cover is integrally formed with a front casing or is disposed on a lens module in a screw locking manner to cause a time-consuming and strenuous cover replacement process, so as to improve convenience of the image surveillance device in cover replacement.

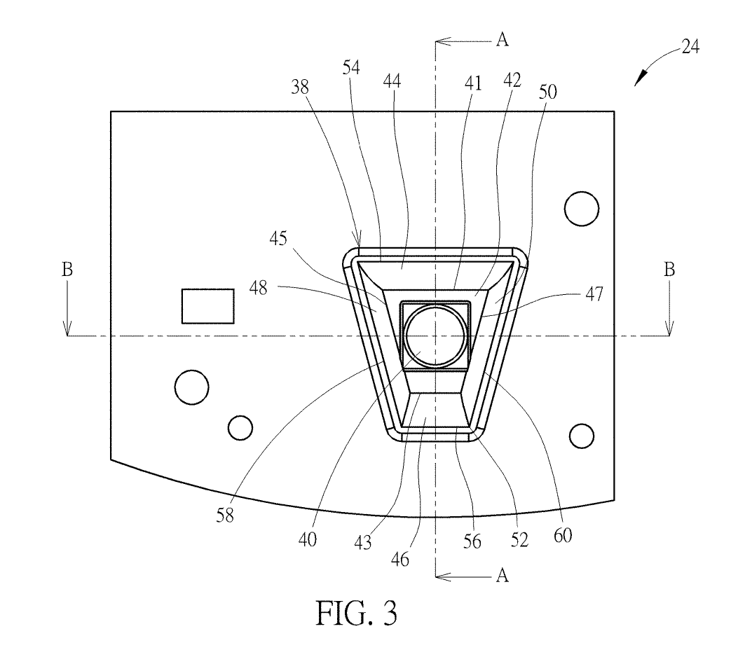

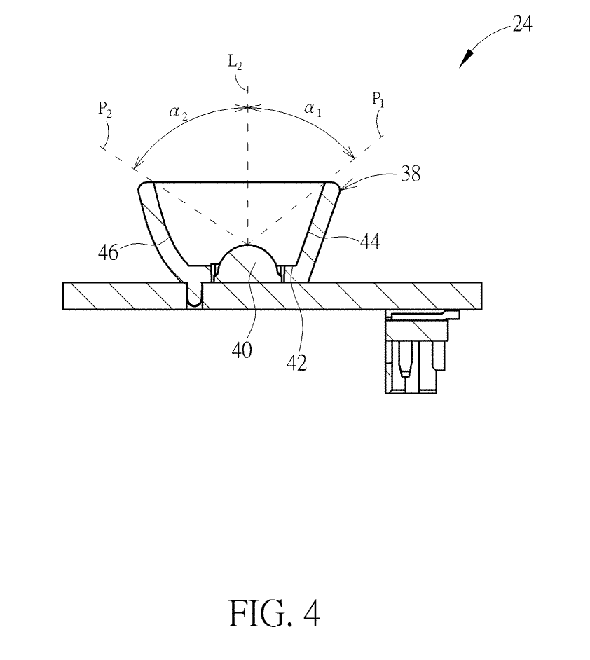

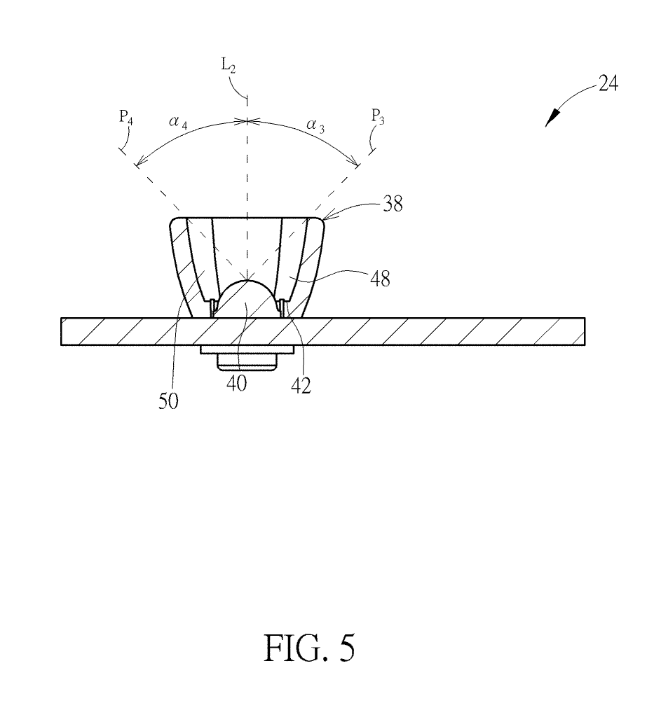

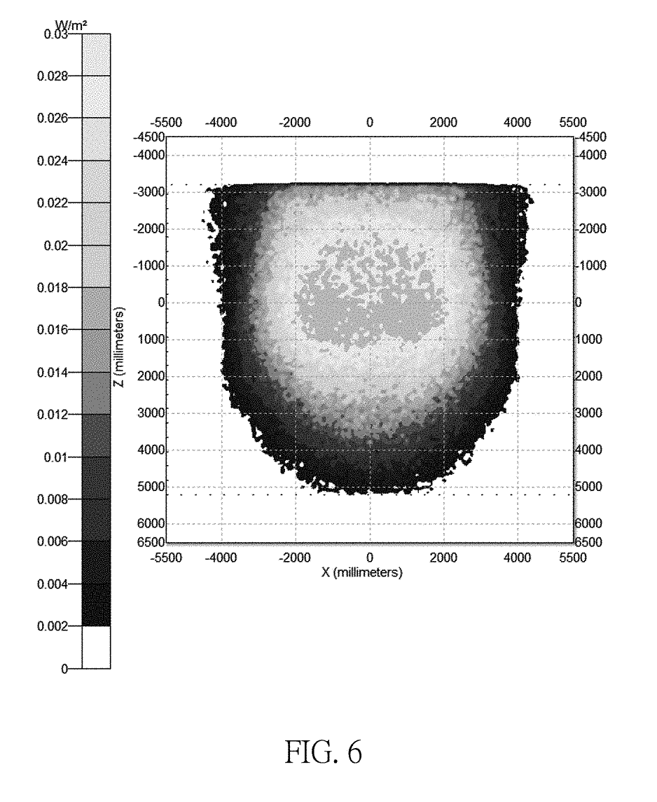

As for the design of the light emitting module 24, please refer to FIG. 2, FIG. 3, FIG. 4, FIG. 5 and FIG. 6. FIG. 3 is a top view of the light emitting module 24 in FIG. 2. FIG. 4 is a cross-sectional diagram of the light emitting module 24 in FIG. 3 along a cross-sectional line A-A. FIG. 5 is a cross-sectional diagram of the light emitting module 24 in FIG. 3 along a cross-sectional line B-B. FIG. 6 is a lighting pattern diagram of the light emitting module 24 in FIG. 3. As shown in FIG. 2, FIG. 3, FIG. 4, and FIG. 5, the light emitting module 24 is disposed in the containing groove 34 and adjacent to the image capturing module 22 for providing the image capturing module 22 with auxiliary light when the image capturing module 22 monitors the surveillance region. The light emitting module 24 includes a cup structure 38 and a light emitting unit 40. The cup structure 38 has an inverted-trapezoid bottom surface 42, a first reflection surface 44, a second reflection surface 46, a third reflection surface 48, a fourth reflection surface 50, and an inverted-trapezoid cup rim 52 (preferably in an isosceles trapezoid shape as shown in FIG. 3, but not limited thereto). The light emitting unit 40 (preferably an infrared LED, but not limited thereto, meaning that the present invention could adopt other type of LED, such as a visible light emitting diode) is disposed on the inverted-trapezoid bottom surface 42. An area of the inverted-trapezoid bottom surface 42 is less than an area of the inverted-trapezoid cup rim 52 to make the cup structure 38 be in an approximate bell-mouth shape. The first reflection surface 44 extends from a topline 41 of the inverted-trapezoid bottom surface 42 to a topline 54 of the inverted-trapezoid cup rim 52. The second reflection surface 46 extends from a baseline 43 of the inverted-trapezoid bottom surface 42 to a baseline 56 of the inverted-trapezoid cup rim 52. The third reflection surface 48 and the fourth reflection surface 50 extend from two lateral sides 45 and 47 of the inverted-trapezoid bottom surface 42 to two lateral sides 58 and 60 of the inverted-trapezoid cup rim 52 respectively.

Via the aforesaid design that the cup structure 38 has the inverted-trapezoid cup rim 52 formed thereon, light emitted by the light emitting unit 40 can be incident to the surveillance region corresponding to the corner wall structure 12 in a lighting pattern as shown in FIG. 6 via reflection of the first reflection surface 44, the second reflection surface 46, the third reflection surface 48, and the fourth reflection surface 50. In such a manner, as shown in FIG. 6, a bottom half portion of the lighting pattern projected by the light emitting unit 40 caused by the cup structure 38 can be in an inverted-triangle shape, so as to be substantially parallel to the first side surface 14 and the second side surface 16 in a surveillance image (substantially in an inverted-triangle shape) captured by the image capturing module. Accordingly, the illumination focus effect can be achieved. Thus, the present invention can avoid the condition that more than fifty percent of light is incident to the two side surfaces adjacent to the image surveillance device rather than the surveillance region of interest in a center area of indoor space, to efficiently solve the aforesaid image underexposure problem and the wall image overexposure problem, such that efficiency in use of light and image clarity of the image surveillance device 10 can be greatly improved.

In this embodiment, an angle α₁ included between a light path P₁ extending from the light emitting unit 40 to the topline 54 of the inverted-trapezoid cup rim 52 and an optical axis L₂ of the light emitting unit 40 is preferably less than an angle α₂ included between a light path P₂ extending from the light emitting unit 40 to the baseline 56 of the inverted-trapezoid cup rim 52 and the optical axis L₂ of the light emitting unit 40. For example, the angle α₁ could be equal to 40° and the angle α₂ could be equal to 45° to make a vertical light emitting angle of the light emitting module 24 be equal to 85°, but not limited thereto. The first reflection surface 44 could preferably be a flat surface, the second reflection surface 46 could preferably be an inwardly-recessed surface, and the topline 41 of the inverted-trapezoid bottom surface 42 and the topline 54 of the inverted-trapezoid cup rim 52 could preferably be parallel to the ceiling surface 18. Furthermore, an angle α₃ included between the optical axis L₂ of the light emitting unit 40 and a light path P₃ extending from the light emitting unit 40 to the lateral side 58 of the inverted-trapezoid cup rim 52 is equal to an angle α₄ included between the optical axis L₂ of the light emitting unit 40 and a light path P₄ extending from the light emitting unit 40 to the lateral side 60 of the inverted-trapezoid cup rim 52. For example, the angle α₃ and the angle α₄ could be equal to 30° respectively to make a horizontal light emitting angle of the light emitting module 24 be equal to 60°, but not limited thereto. The third reflection surface 48 and the fourth reflection surface 50 could preferably be two inwardly-recessed surfaces symmetrical to each other.

In such a manner, light toward a corner area under the image surveillance device 10 can be reflected by the second reflection surface 46, and light toward the first side surface 14 and the second side surface 16 can be reflected by the third reflection surface 48 and the fourth reflection surface 50 respectively, so that light of the light emitting unit 40 can be incident to the center area of indoor space more intensively for providing sufficient illumination to the surveillance region of interest. Accordingly, the image capturing module 22 can capture clear images of the surveillance region of interest.

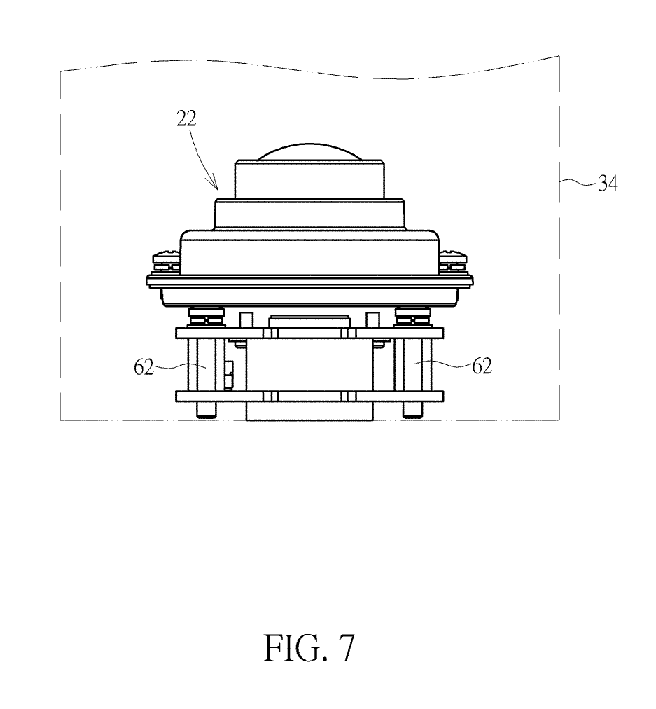

Furthermore, please refer to FIG. 7, which is a side view of the image capturing module 22 in FIG. 2 being disposed in the containing groove 34. The containing groove 34 is partially depicted by dotted lines in FIG. 7. As shown in FIG. 7, the casing 20 could further include at least one support pillar 62 (two shown in FIG. 7, but not limited thereto). The support pillar 62 could preferably be a screw post (but not limited thereto), and could be connected between the image capturing module 22 and the containing groove 34 for adjusting the mounting height of the image capturing module 22 in the containing groove 34. Accordingly, via the design that the support pillar 62 could be utilized to properly adjust the mounting height of the image capturing module 22 in the containing groove 34, the present invention not only prevents that the cover 30 cannot be assembled with the containing plate 28 due to structural interference between the image capturing module 22 and the cover 30, but also achieves the purpose that the image surveillance device 10 could be suitable to image capturing modules with different structural heights (e.g. a fisheye camera module).

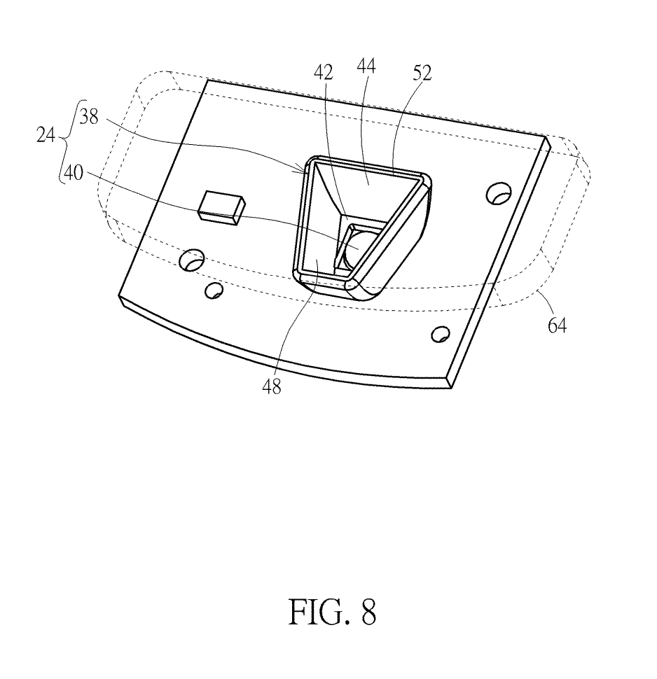

Moreover, please refer to FIG. 2 and FIG. 8. FIG. 8 is a diagram of a second transparent mask 64 in FIG. 2 being flat on the inverted-trapezoid cup rim 52 of the cup structure 38. For clearly showing the structural relationship between the cup structure 38 and the second transparent mask 64, the second transparent mask 64 is briefly depicted by dotted lines in FIG. 8. As shown in FIG. 2 and FIG. 8, in this embodiment, the cover 30 could further include the second transparent mask 64. After the cover 30 is fixed to the containing plate 28 to cover the opening 32, the cup structure 38 could abut against the second transparent mask 64 to make the inverted-trapezoid cup rim 52 flat on the second transparent mask 64, so as to make light of the light emitting unit 40 incident to the surveillance region through the second transparent mask 64. In such a manner, via the design that the second transparent mask 64 is flat on the inverted-trapezoid cup rim 52 of the cup structure 38, the present invention can surely prevent light of the light emitting unit 40 from being incident to the image capturing module 22 through a structural gap between the cover 30 and the containing plate 28, so as to solve the hot spot problem.

It should be mentioned that the design that the cover is detachably disposed on the containing plate and the design that the cup structure has the inverted-trapezoid cup rim could be omitted alternatively for simplifying the structural design of the image surveillance device of the present invention. For example, in another embodiment, the image surveillance device of the present invention could adopt the design that the cover is detachably disposed on the containing plate with a conventional cup structural design (e.g. the cup structure has a square cup rim) or without a lighting design, or could adopt the design that the cup structure has the inverted-trapezoid cup rim with the design that the cover is integrally formed with the containing plate or is disposed on the image capturing module in a screw locking manner. As for which design is adopted, it depends on the practical application of the image surveillance device of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image surveillance device mounted on a corner wall structure, the corner wall structure having a first side surface, a second side surface, and a ceiling surface, the image surveillance device comprising:
a casing comprising:
a mounting plate detachably connected to the first side surface, the second side surface, and the ceiling surface to be fixed to the corner wall structure;
a containing plate detachably contained in the mounting plate, the containing plate having an opening and a containing groove recessed inwardly from the opening; and
a cover detachably covering the opening and having a first transparent mask; and
an image capturing module disposed in the containing groove corresponding to the first transparent mask, an oblique angle being included between an optical axis of the image capturing module and the ceiling surface to make the image capturing module obliquely monitor a surveillance region corresponding to the corner wall structure through the first transparent mask.

2. The image surveillance device of claim 1, wherein the casing further comprises at least one support pillar, and the support pillar is connected to the image capturing module and the containing groove for adjusting a mounting height of the image capturing device in the containing groove.

3. The image surveillance device of claim 1 further comprising:
at least one light emitting module disposed in the containing groove and adjacent to the image capturing module for providing the image capturing module with light when the image capturing module monitors the surveillance region, the light emitting module comprising:
a cup structure having an inverted-trapezoid bottom surface, a first reflection surface, a second reflection surface, a third reflection surface, a fourth reflection surface, and an inverted-trapezoid cup rim, an area of the inverted-trapezoid bottom surface being less than an area of the inverted-trapezoid cup rim, the first reflection surface extending from a topline of the inverted-trapezoid bottom surface to a topline of the inverted-trapezoid cup rim, the second reflection surface extending from a baseline of the inverted-trapezoid bottom surface to a baseline of the inverted-trapezoid cup rim, the third reflection surface and the fourth reflection surface extending from two lateral sides of the inverted-trapezoid bottom surface to two lateral sides of the inverted-trapezoid cup rim respectively; and
a light emitting unit disposed on the inverted-trapezoid bottom surface, light emitting by the light emitting unit being incident to the surveillance region via reflection of the first reflection surface, the second reflection surface, the third reflection surface, and the fourth reflection surface.

4. The image surveillance device of claim 3, wherein a first angle included between a light path extending from the light emitting unit to the topline of the inverted-trapezoid cup rim and an optical axis of the light emitting unit is less than a second angle included between a light path extending from the light emitting unit to the baseline of the inverted-trapezoid cup rim and the optical axis of the light emitting unit.

5. The image surveillance device of claim 4, wherein the first reflection surface is a flat surface, and the second reflection surface is an inwardly-recessed surface.

6. The image surveillance device of claim 5, wherein the topline of the inverted-trapezoid bottom surface and the topline of the inverted-trapezoid cup rim are substantially parallel to the ceiling surface.

7. The image surveillance device of claim 3, wherein an angle included between an optical axis of the light emitting unit and a light path extending from the light emitting unit to one lateral side of the inverted-trapezoid cup rim is equal to an angle included between the optical axis of the light emitting unit and a light path extending from the light emitting unit to the other lateral side of the inverted-trapezoid cup rim.

8. The image surveillance device of claim 7, wherein the third reflection surface and the fourth reflection surface are two inwardly-recessed surfaces symmetrical to each other.

9. The image surveillance device of claim 8, wherein the topline of the inverted-trapezoid bottom surface and the topline of the inverted-trapezoid cup rim are substantially parallel to the ceiling surface.

10. The image surveillance device of claim 3, wherein the cover further has a second transparent mask, the cup structure abuts against the second transparent mask to make the inverted-trapezoid cup rim flat on the second transparent mask, and the light emitted by the light emitting unit is incident to the surveillance region through the second transparent mask.

11. An image surveillance device mounted on a corner wall structure, the corner wall structure having a first side surface, a second side surface, and a ceiling surface, the image surveillance device comprising:
a casing detachably connected to the first side surface, the second side surface, and the ceiling surface to be fixed to the corner wall structure;
an image capturing module disposed in the casing, an oblique angle being included between an optical axis of the image capturing module and the ceiling surface to make the image capturing module obliquely monitor a surveillance region corresponding to the corner wall structure; and
at least one light emitting module disposed in the casing and adjacent to the image capturing module for providing the image capturing module with light when the image capturing module monitors the surveillance region, the light emitting module comprising:
a cup structure having an inverted-trapezoid bottom surface, a first reflection surface, a second reflection surface, a third reflection surface, a fourth reflection surface, and an inverted-trapezoid cup rim, an area of the inverted-trapezoid bottom surface being less than an area of the inverted-trapezoid cup rim, the first reflection surface extending from a topline of the inverted-trapezoid bottom surface to a topline of the inverted-trapezoid cup rim, the second reflection surface extending from a baseline of the inverted-trapezoid bottom surface to a baseline of the inverted-trapezoid cup rim, the third reflection surface and the fourth reflection surface extending from two lateral sides of the inverted-trapezoid bottom surface to two lateral sides of the inverted-trapezoid cup rim respectively; and
a light emitting unit disposed on the inverted-trapezoid bottom surface, light emitting by the light emitting unit being incident to the surveillance region via reflection of the first reflection surface, the second reflection surface, the third reflection surface, and the fourth reflection surface.

12. A light emitting module providing light to an image capturing module mounted on a corner wall structure when the image capturing module obliquely monitors a surveillance region, the light emitting module comprising:
a cup structure having an inverted-trapezoid bottom surface, a first reflection surface, a second reflection surface, a third reflection surface, a fourth reflection surface, and an inverted-trapezoid cup rim, an area of the inverted-trapezoid bottom surface being less than an area of the inverted-trapezoid cup rim, the first reflection surface extending from a topline of the inverted-trapezoid bottom surface to a topline of the inverted-trapezoid cup rim, the second reflection surface extending from a baseline of the inverted-trapezoid bottom surface to a baseline of the inverted-trapezoid cup rim, the third reflection surface and the fourth reflection surface extending from two lateral sides of the inverted-trapezoid bottom surface to two lateral sides of the inverted-trapezoid cup rim respectively; and
a light emitting unit disposed on the inverted-trapezoid bottom surface, light emitting by the light emitting unit being incident to the surveillance region via reflection of the first reflection surface, the second reflection surface, the third reflection surface, and the fourth reflection surface.

13. The light emitting module of claim 12, wherein a first angle included between a light path extending from the light emitting unit to the topline of the inverted-trapezoid cup rim and an optical axis of the light emitting unit is less than a second angle included between a light path extending from the light emitting unit to the baseline of the inverted-trapezoid cup rim and the optical axis of the light emitting unit.

14. The light emitting module of claim 13, wherein the first reflection surface is a flat surface, and the second reflection surface is an inwardly-recessed surface.

15. The light emitting module of claim 14 wherein the corner wall structure has a first side surface, a second side surface and a ceiling surface, and the topline of the inverted-trapezoid bottom surface and the topline of the inverted-trapezoid cup rim are substantially parallel to the ceiling surface.

16. The light emitting module of claim 12, wherein an angle included between an optical axis of the light emitting unit and a light path extending from the light emitting unit to one lateral side of the inverted-trapezoid cup rim is equal to an angle included between the optical axis of the light emitting unit and a light path extending from the light emitting unit to the other lateral side of the inverted-trapezoid cup rim.

17. The light emitting module of claim 16, wherein the third reflection surface and the fourth reflection surface are two inwardly-recessed surfaces symmetrical to each other.

18. The light emitting module of claim 17, wherein the corner wall structure has a first side surface, a second side surface and a ceiling surface, the topline of the inverted-trapezoid bottom surface and the topline of the inverted-trapezoid cup rim are substantially parallel to the ceiling surface.
